(19) United States
(12) Patent Application Publication
(10) Pub. No.: US 2003/0105659 A1
(43) Pub. Date: Jun. 5, 2003

(54) Transaction-based survey system

(76) Inventor: Jonathan Eisenstein, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 10/010,779

(22) Filed: Dec. 3, 2001

(51) Int. Cl. G06F 17/60

(52) U.S. Cl. 705/10

(57) ABSTRACT

A system to administer a survey includes reception of indications from a user of one or more fields of a database, the fields specifying information, determination that the one or more criteria have been satisfied based on information specified in the one or more fields, and transmission of the survey to a respondent based on the determination.

### BACKGROUND

1. Field

The present invention relates to systems for administering surveys. More specifically, the present invention concerns a system to administer a survey in response to a completed transaction and/or based on criteria evaluated using user-specified fields of a database.

2. Discussion of the Prior Art

Many types of entities, including manufacturers, retailers, market analysts, political groups and news agencies, use surveys to obtain feedback from respondents. Such feedback may include demographic information describing a respondent as well as information representing impressions, attitudes, concerns, and beliefs of the respondent. Surveys usually include specific questions directed to a particular topic. For example, a product manufacturer may create a survey including questions related to a product, such as “How would you rate your satisfaction with the product on a scale of 1 to 10?” or “Would you recommend the product to a friend?”

A number of methods may be used to administer a survey to one or more respondents. One conventional method includes oral transmission of survey questions to a respondent, by telephone or in-person, and manual recordation of responses to the questions. According to another method, an entity mails a survey to respondents with instructions to complete the survey and to transmit the survey back to the entity. Both of these conventional methods fail to provide satisfactory response rates, response times, targeting of particular respondents, and control over survey timing.

Recently-developed surveying systems have sought to address the foregoing problems. According to some of these systems, a survey is transmitted to a respondent over the World Wide Web (“Web”). More particularly, a respondent requests a Web page from a Web server and, in response to the request, the Web server presents the respondent with the Web page as well as with a pop-up window including a survey. In other examples, the accessed Web page includes a link to another Web page that includes the survey. Presentation of the pop-up window or of the link may occur at anytime during communication with the Web server, including after a purchase transaction or after the respondent registers with a website provided by the Web server. In still other examples, completion of such a transaction or registration causes the Web server to transmit to the respondent an electronic mail message that includes a link to a survey located on the Web.

While these Web-based systems may be more cost efficient than the previously-described systems, the Web-based systems usually have lower response rates and less reliable responses. These characteristics are believed to be caused in part by respondents' developed ability to navigate away from undesirable Web content. That is, a typical respondent is so often confronted with uninteresting or intrusive pop-up windows or Web pages that he develops an ability to quickly and easily remove these objects from his view, either by closing the windows/pages or by entering dummy information in required fields.

Other recently-developed systems provide surveys to respondents using electronic mail. According to these systems, a user creates a survey and specifies those respondents who should receive survey. An electronic mail message including the survey is generated and the message is transmitted to the specified respondents either immediately in response to a command from the user or according to a scheduled delivery time. These systems fail to provide the user with sufficient flexibility and control in determining when and to whom surveys are transmitted. For example, a respondent must be known to the user in order to be specified, and a survey cannot be transmitted automatically in response to the occurrence of an event.

In view of the foregoing, what is needed is a system to elicit information from respondents in which response rates are improved over existing systems for eliciting information based on certain criteria. Such a system preferably provides increased control over survey delivery and a capability to generate, administer and evaluate responses to surveys based on information received from databases that are not integrally associated with the system.

### SUMMARY

In order to address the foregoing, aspects of the present invention concern a system, a user interface, a method, an apparatus, means, and a computer-readable medium storing processor-executable process steps to elicit a response from a respondent in which an indication is received that a transaction has been completed, and, in response to the indication, an electronic mail message is transmitted to a respondent, the message including one or more questions concerning the transaction.

In another aspect, a first device is provided for receiving an indication that a transaction has been completed and for transmitting, in response to the indication, one or more questions concerning the transaction to a respondent in an electronic mail message. Also provided is a second device for receiving one or more responses to the one or more questions, for generating a report based on the one or more responses, and for providing the report to the first device.

Other aspects include generation of a survey comprising one or more questions, definition of a transaction in response to the completion of which the survey should be transmitted, detection of completion of the transaction, and transmission of the survey to a respondent in an electronic mail message in response to the detection.

In yet another aspect, one or more responses are received to one or more questions transmitted to a respondent in an electronic mail message in response to detection of a completed transaction, a report is generated based on the one or more responses, and the report is transmitted.

A system according to another aspect includes a client device for generating a survey comprising one or more questions, for defining a transaction, for receiving an indication that the transaction has been completed, and for transmitting, in response to the indication, an electronic mail message comprising one or more questions concerning the transaction to a respondent, a transaction device for storing data indicating that the transaction has been completed and for transmitting the indication that the transaction has been completed, and a server device for receiving one or more responses to the one or more questions, for generating a report based on the one or more responses, and for providing the report to the client device.

Other aspects of the invention include reception of indications from a user of one or more fields of a database, the fields specifying information, reception from the user of an association between a survey and one or more criteria, determination that the one or more criteria have been satisfied based on information specified in the one or more fields, and transmission of the survey to a respondent based on the determination.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a diagram of a system architecture according to embodiments of the invention.

FIG. 2 is a block diagram illustrating an internal architecture of a user device according to embodiments of the present invention.

FIG. 3 is a block diagram illustrating an internal architecture of a response server according to embodiments of the present invention.

FIG. 4 is a block diagram illustrating an internal architecture of a help desk server according to embodiments of the present invention.

FIG. 5 is a block diagram illustrating an internal architecture of a respondent device according to embodiments of the present invention.

FIG. 6 is a tabular representation of a portion of a sent survey database according to embodiments of the present invention.

FIG. 7 is a tabular representation of a portion of a response database according to embodiments of the present invention.

FIG. 8 is a tabular representation of a portion of a transaction database according to embodiments of the present invention.

FIG. 9 illustrates a flow diagram of process steps to administer a survey according to embodiments of the invention.

FIG. 10 is a view of a user interface as displayed according to embodiments of the invention.

FIG. 11 is a view of a user interface as displayed according to embodiments of the invention.

FIG. 12 is a view of a user interface as displayed according to embodiments of the invention.

FIG. 13 is a view of a user interface as displayed according to embodiments of the invention.

FIG. 14 is a view of a user interface as displayed according to embodiments of the invention.

FIG. 15 is a view of a user interface as displayed according to embodiments of the invention.

FIG. 16 is a view of a user interface as displayed according to embodiments of the invention.

FIG. 17 is a view of a user interface as displayed according to embodiments of the invention.

FIG. 18 is a view of an electronic mail message including a survey according to embodiments of the present invention.

FIG. 19 is a view of a Web page including a report of survey results according to embodiments of the present invention.

### DETAILED DESCRIPTION

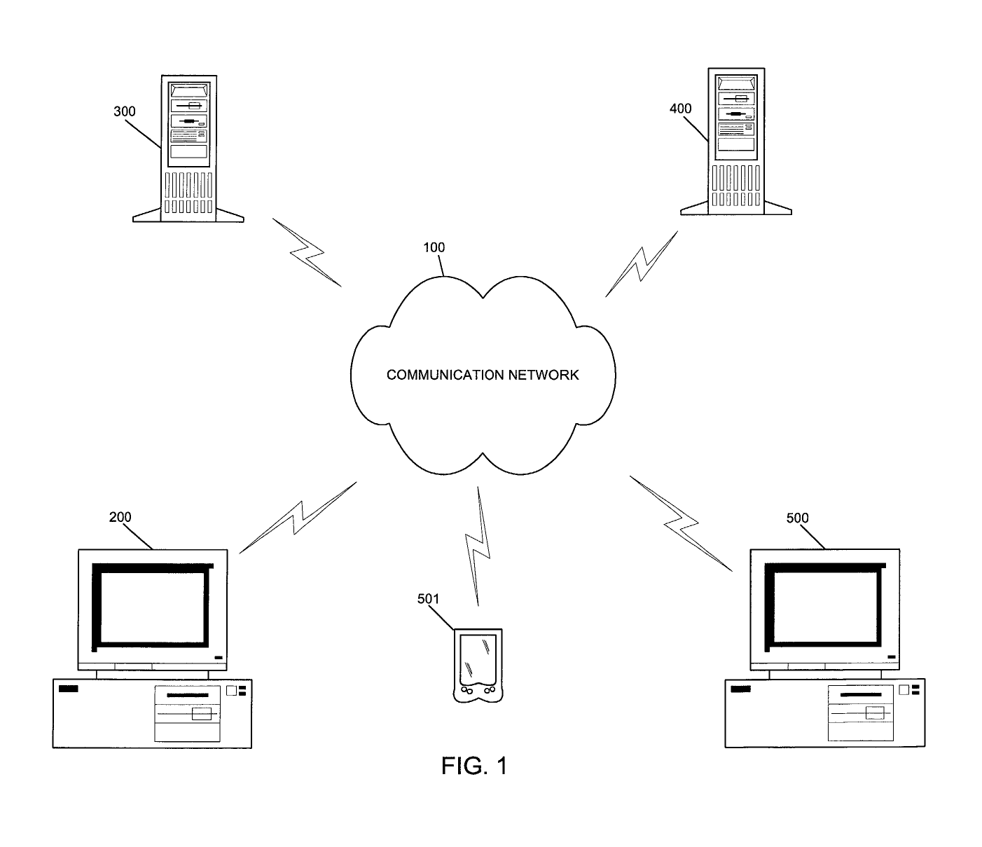

FIG. 1 illustrates a network architecture for administering a survey and for viewing survey results according to some embodiments of the present invention. As shown, communication network 100 provides communication between user device 200, response server 300, help desk server 400 and respondent devices 500 and 501. Communication network 100 may comprise any number of systems for transferring data, including a local area network, a wide area network, the Internet, a telephone network, a cellular network, a fiber-optic network, a satellite network, an infra-red network, a radio frequency network, and any other type of network which may be used to transmit information between devices. Moreover, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In some embodiments, communication network 100 is the World Wide Web.

User device 200 may comprise a workstation operated by any user, including a survey administrator. User device 200 may also comprise any device or devices capable of performing the steps attributed to user device 200 herein. Generally, a user operates user device 200 to generate a survey, to define criteria, such as a completed transaction, based on which the survey should be transmitted, to determine that the criteria have been satisfied, to transmit the survey to a respondent, to request a report of survey results, and to display the report. User device 200 may also provide a user with functions that are unrelated to the present invention, such as electronic mail, word processing, and spreadsheet functions.

Response server 300 of FIG. 1 comprises a server for receiving survey responses from respondent devices 500 and 501, for storing survey responses, for generating a report of survey results, and for transmitting the report to requesting devices such as user device 200. Response server 300 may be owned and operated by an entity that owns and operates user device 300, by an entity providing software to user device 200 for performing steps of the present invention, or by another entity. In this regard, response server 300 may provide functions other than those related to the present invention.

User device 200 determines if the above-mentioned criteria are satisfied by accessing information stored in help desk server 400. Help desk server 400 executes process steps to provide help desk services to devices with which it is in communication over communication network 100. In providing these services, help desk server 400 stores information related to each help desk transaction, or “ticket”, such as associated user, date and time opened, nature of problem, and date and time closed. User device 200 accesses this information according to some embodiments of the invention to determine if certain criteria have been satisfied. Help desk server 400 need not be dedicated to providing help desk services, but may also provide other functions to its operating entity such as accounting, billing, file serving, or the like.

Electronic mail messages including surveys are transmitted from user device 200 to respondent devices 500 and 501, respectively comprising a Personal Digital Assistant and a desktop computer. Respondent devices 500 and 501 may be used to provide a respondent with functionality unrelated to the present invention, including word processing, personal electronic mail, audio, and Web access. In some embodiments, respondent devices 500 and 501 provide only an HTML-enables client program and a connection to the Web. It should be noted that devices other than those particular devices representing response server 300, help desk server 400 and respondent devices 500 and 501 in FIG. 1 may be used to perform the functions attributed to the devices herein.

In other embodiments, the devices of FIG. 1 are connected differently than as shown. For example, some or all of the devices may be connected directly to one another. Of course, embodiments of the invention may include devices that are different from those shown. Moreover, some of the functions attributed to one of the illustrated devices may be performed by another of the illustrated devices.

It should also be noted that although the devices are shown in communication with each other, the devices need not be constantly exchanging data. Rather, communication may be established when necessary and severed at other times or always available but rarely used to transmit data. Additionally, although the illustrated communication links appear dedicated, it should be noted that each of the links may be shared by other devices.

The following description is merely intended to provide the reader with a brief introduction to the operation of the FIG. 1 architecture according to some embodiments; a more detailed description is provided below. Initially, user device 200 executes an application to receive indications from a user of one or more fields of a database stored in help desk server 400. The indicated fields preferably store information relevant for determining whether particular criteria are satisfied. In this regard, user device 200 also generates a survey based on input from the user and allows the user to associate the survey with one or more criteria related to the specified fields. According to the present example, the criteria comprise closure of a help desk ticket within a specified date range.

User device 200 queries the database of help desk server 400 to determine if any records of the database indicate closure of a help desk ticket. More particularly, user device 200 queries the specified fields of the database to identify records that contain closed ticket information. Of the identified records, user device 200 selects those that are associated with a ticket closure within the specified date range. Electronic mail addresses of respondents associated with the selected records are identified from the records and user device 200 transmits an electronic mail message including the survey to each of the respondents.

One of the electronic mail messages is transmitted to an SMTP server (not shown) executing within communication network 100 and is routed thereby to respondent device 501. Respondent device 501 executes an electronic mail client to view the electronic mail message and a respondent operating device 501 uses an input device to respond to questions posed by the survey that is included in the message. The respondent submits the responses by selecting an icon also included in the message and the responses are therefore transmitted to response server 300. In this regard, the electronic mail message is an HTML page including code that respondent device 501 executes to transmit the responses to response server 300 in response to selection of the icon. Accordingly, user device 200 generates the message in a manner that specifies the server to which respondent device 501 should send the responses.

Response server 300 receives the responses and generates a Web page including a report based on the responses. The report may present the responses in any known manner for presenting survey results. User device 200 then executes a Web browser to request the Web page from response server 300 and the Web page is transmitted to user device 200 for display to the user.

By virtue of some of the foregoing features, a user may advantageously send surveys to respondents based on criteria, such as completion of a transaction, that are determinable based on any fields of any accessible database. Moreover, the received surveys may be provided in a simple to use, platform-independent format that may result in high response rates and reliability. A survey administrator may also be provided with platform-independent means for viewing a report based on survey responses. Overall, a system according to some embodiments of the invention may provide more efficient and flexible survey administration than previously available.

User Device

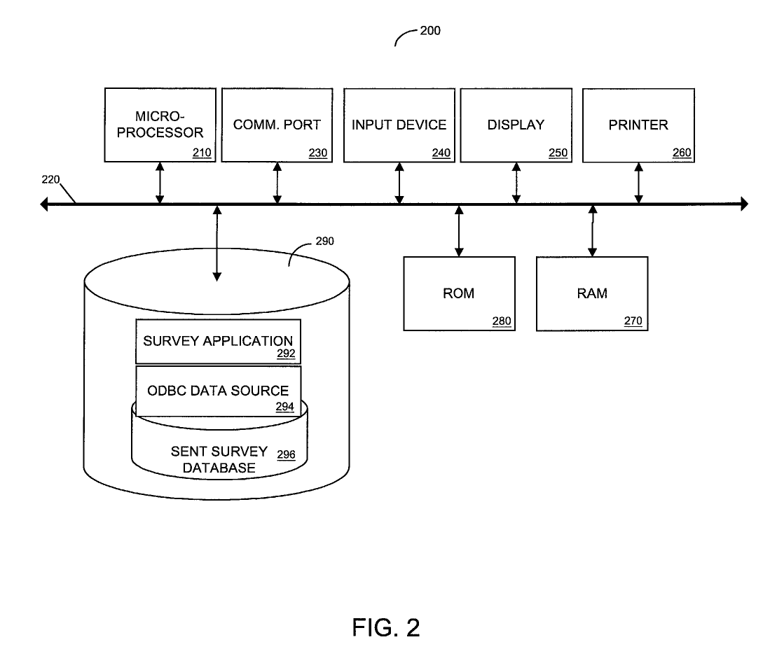

FIG. 2 is a block diagram of an internal architecture of user device 200 according to embodiments of the invention. As illustrated, user device 200 includes microprocessor 210 in communication with communication bus 220. Microprocessor 210 may be a Pentium, RISC-based, or other type of processor and is used to execute processor-executable process steps so as to control the elements of user device 200 to provide desired functionality.

Also in communication with communication bus 220 is communication port 230. Communication port 230 is used to transmit data to and to receive data from devices external to user device 200. Communication port 230 is therefore preferably configured with hardware suitable to physically interface with desired external devices and/or network connections. For example, communication port 230 may comprise an Ethernet connection to a local area network through which user device 200 may transmit information, such as database queries and electronic mail messages, and receive information, such as database field information and Web pages, over the Web.

Input device 240, display 250 and printer 260 are also in communication with communication bus 220. Any known input device may be used as input device 240, including a keyboard, mouse, touch pad, voice-recognition system, or any combination of these devices. Input device 240 may be operated by a user of user device 200 to input an indication of a database, indications of fields of the database, survey questions, criteria for transmitting a survey, and other information. Of course, such information may also be input to user device 200 via communication port 230.

Information may be presented to a user via display 250, which may be an integral or separate CRT display, flat-panel display, LCD projector, or the like, in response to commands issued by microprocessor 210. Such information may include Web pages, user interfaces, or other text and graphics. Printer 260 may also present text and graphics to a user, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, processor-executable process steps of survey application 292. Microprocessor 210 executes the process steps of survey application 292 in order to control user device 200 to administer a survey according to embodiments of the present invention. More specifically, the process steps of survey application 292 may be executed by microprocessor 210 to cause user device to generate a survey, to define criteria, such as a completed transaction, based on which the survey should be transmitted, to access fields of a database so as to determine that the criteria have been satisfied, to transmit the survey to a respondent, to request a report of survey results, or to display the report.

The process steps of survey application 292 may be read from a computer-readable medium, such as a floppy disk, a CD-ROM, a DVD-ROM, a Zip™ disk, a magnetic tape, or a signal encoding the process steps, and thereafter stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Survey application 292 may also comprise processor-executable process steps of a Web browser. The process steps may be executed by microprocessor 210 to transmit data to and to receive data from Web servers over the Web. As described above, the data may include requests for Web pages as well as Web pages including reports of survey results.

ODBC (Open DataBase Connectivity) data source 294 comprises processor-executable process steps used to communicate with a database. ODBC refers to a standard database access method that allows an application capable of issuing ODBC commands to access any data stored in a database that is managed by a database management system (DBMS) capable of responding to ODBC commands. In the present example, a DBMS that manages a transaction database of help desk server 400 supports ODBC communication. Therefore, survey application 292 may use ODBC data source 294 to access data stored in the transaction database. ODBC data source 294 may be provided by an operating system of user device 200 and/or may be included within survey application 292.

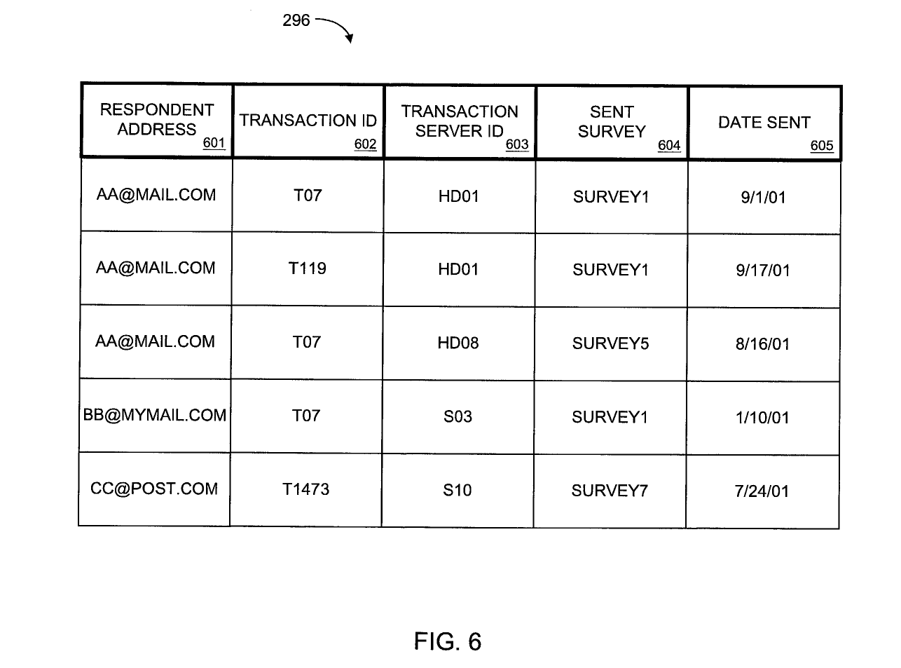

Sent survey database 296 is also stored in data storage device 290. Sent survey database 296 includes information related to surveys previously sent by electronic mail to respondents. Such information may be used to determine whether to transmit a particular survey to a respondent. This ability may be useful in cases where the user wishes to avoid transmitting a same survey several times to a same respondent, or to avoid sending more than a particular number of surveys to a particular respondent. One example of sent survey database 296 is described below with respect to FIG. 6.

Also stored in data storage device 290 may also be other unshown elements that may be necessary for operation of user device 200, such as other applications, other data files, the operating system, a database management system and “device drivers” for allowing microprocessor 210 to interface with devices in communication with communication port 230. These elements are known to those skilled in the art, and are therefore not described in detail herein.

Response Server

Other devices described below and illustrated herein include distinct components that are identified using names identical to some components of user device 200. It should be noted that these distinct components may comprise any of the specific examples offered with respect to identically-named components of user device 200. Of course, specific functions performed by the components may differ from the functions performed by the identically-named components.

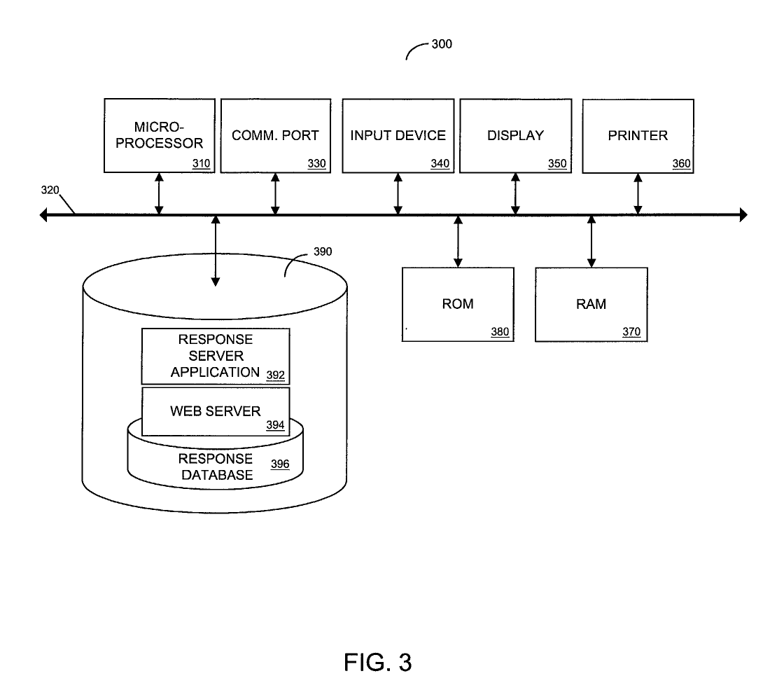

In this regard, FIG. 3 illustrates several components of response server 300 according to some embodiments of the invention. Communication port 330 may be used to receive responses to survey questions, and to transmit Web pages including reports. Such reports may be created and transmitted based on rules input by an operator using input device 340, and may be output using display 350 and printer 360. Input device 340, display 350 and printer 360 may also be used in conjunction with other applications provided by response server 300 which are unrelated to the present invention.

Data storage device 390 stores processor-executable process steps of response server application 392, Web server 394, and response database 396. The process steps of response server application 392 may be executed by microprocessor 310 to allow response server 300 to generate reports based on received survey responses and to create Web pages including the reports. The process steps may be received by server 300 and stored in data storage device 390 using any known method.

In some embodiments, response server application 392 includes process steps attributed herein to survey application 292. As a result, a user of a device networked to server 300 may be able to administer a survey as described herein through response server 300.

Process steps of Web server 394 may be executed to allow response server 300 to receive requests from and to transmit Web pages to a device executing process steps of a Web client, such as a Web browser.

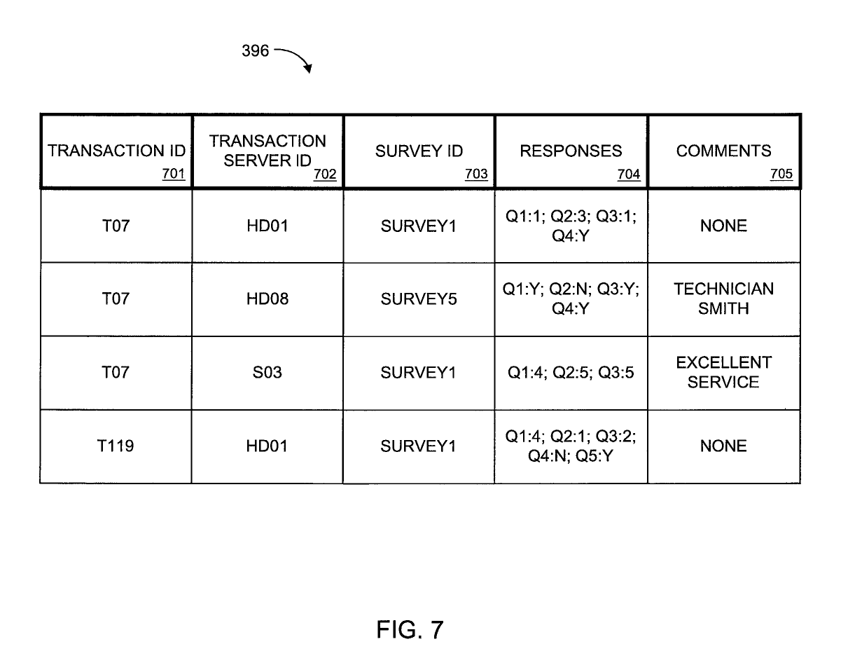

Response database 396 stores responses received from respondents and is therefore used to generated the aforementioned reports. Response database 396 may also specify information such as an associated question, comments, and an identity of a help desk server from which a response was received. An embodiment of response database 396 is described below with respect to FIG. 7.

Data storage device 390 may also store application files, data files and system files other than those shown in FIG. 3. These files may be used to provide an operator with functions other than that provided by the present invention, such as e-mail functions, word processing functions, and the like.

Help Desk Server

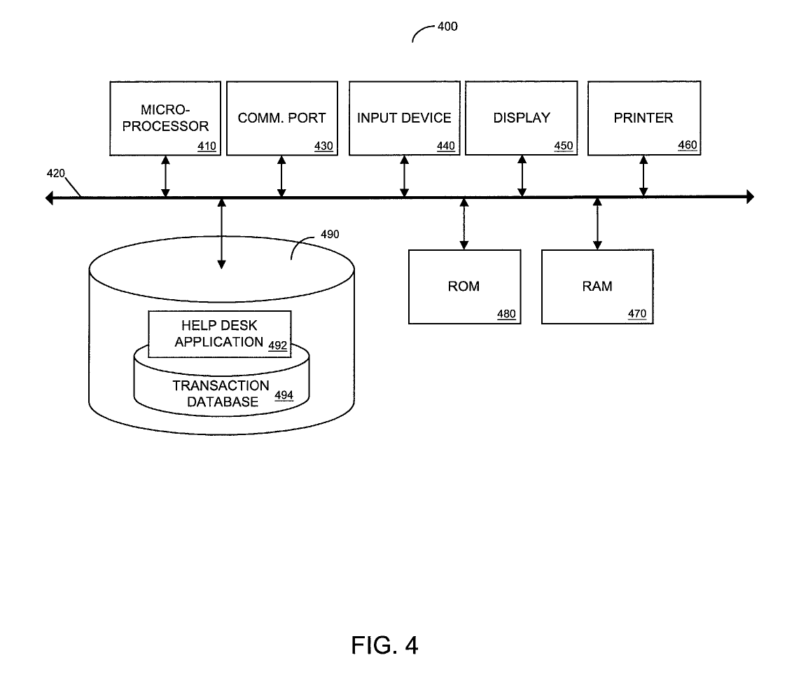

Several components of help desk server 400 are illustrated in FIG. 4. Communication port 430 may be used to receive requests for information stored in database fields and to transmit the requested information. Input device 440, display 450 and printer 460 may be used to perform help desk operations or any other functions provided by help desk server 300.

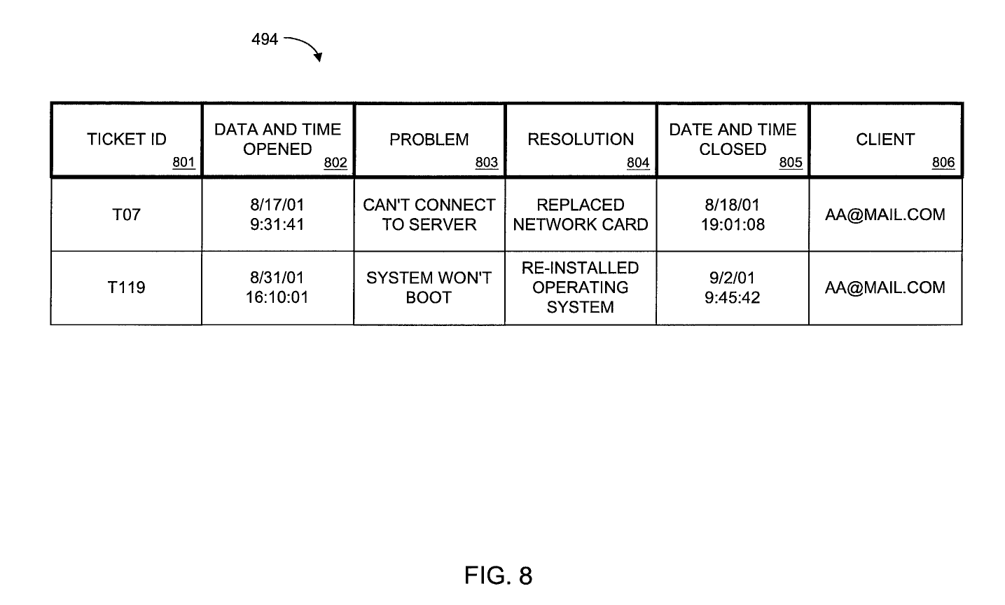

Help desk application 492 is stored in data storage device 490. Help desk application 492 includes processor-executable process steps executable by microprocessor 410 to provide a help desk application. Also stored in data storage device 490 is transaction database 494, which records information concerning help desk transactions. As briefly described above, user device 200 queries fields of transaction database 494 to determine whether criteria are satisfied when determining whether to transmit a survey. An example of a portion of transaction database 494 is shown in FIG. 8.

Advantageously, some embodiments of the invention do not require help desk application 492 and transaction database 494 to be designed with the invention in mind. That is, any application and associated database may be used in conjunction with some embodiments of the present invention to administer surveys based on criteria that may be evaluated using information specified in the database.

Respondent Device

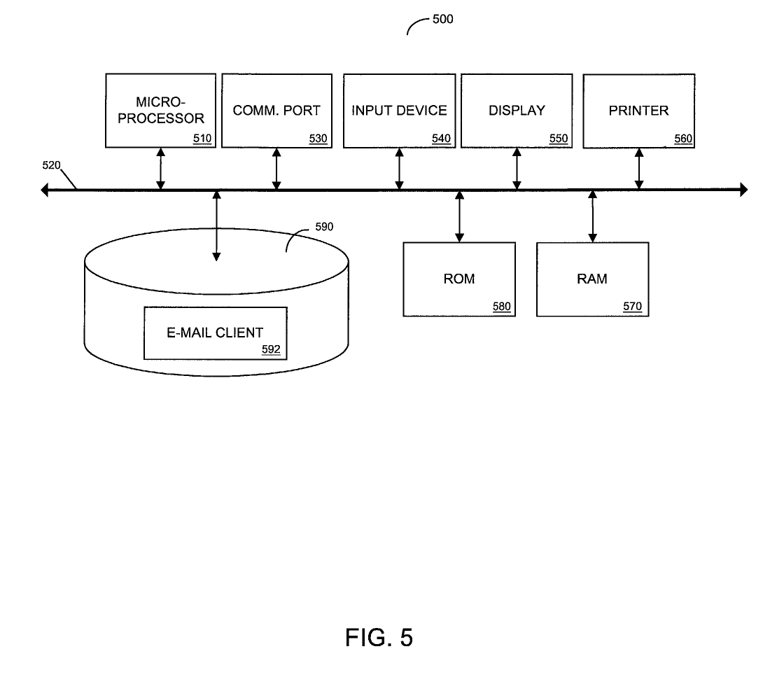

FIG. 5 illustrates components of respondent device 500. As described above, respondent device 500 may comprise a general-purpose device that provides a respondent with functions such as electronic mail, word processing, and Web browsing functions. Accordingly, components 510 through 590 may operate so as to provide these functions.

In addition, communication port 530 may be used to receive electronic mail messages including surveys from user device 200 and to transmit survey responses to response server 300. Responses may be input using input device 540 to a window displaying the electronic message on display 550. Electronic mail client 592 of data storage device 590 is executed to receive electronic mail from a mail server associated with respondent device 500. Electronic mail client 592 may be capable of receiving, presenting and transmitting electronic mail messages comprising Web pages. This capability allows respondent device 500 to transmit survey responses as well as associated information described below to Web server 394 of response server 300.

Sent Survey Database

A tabular representation of a portion of sent survey database 296 is shown in FIG. 6. Sent survey database 296 includes information related to surveys previously sent to respondents by electronic mail. The portion includes several records, with each record consisting of several associated fields. The fields include respondent address field 601, transaction ID field 602, transaction server ID field 603, sent survey field 604, and date sent field 605. The information stored in sent survey database 296 may be generated by user device 200 and may be received from transaction database 494 or from another source.

Respondent address field 601 of a record specifies an electronic mail address of a respondent to whom a survey was sent. The information of respondent address field 601 may be received from transaction database 494 along with other information specified in the record. In this regard, transaction ID field 602 of the same record specifies a transaction recorded in transaction database 494 in association with the respondent address of field 601. The specified transaction may be any type of transaction for which details are recorded in transaction database 494. As described herein, these details may be evaluated to determine if criteria for transmitting a survey to a respondent are met.

Transaction server field 603 identifies a transaction server storing data in conjunction with an associated transaction ID of field 602. Transaction server ID field 603 is used in conjunction with transaction ID field 602 to identify a transaction because of the possibility that different transaction servers with which user device 200 is in communication may use identical transaction IDs. A transaction server may be assigned a particular transaction server ID for use in transaction server ID field 603 upon initial communication with user device 200. As a result, different user devices embodying the invention may assign different transaction server IDs to a same transaction server.

Sent survey field 604 of a record identifies a survey that was sent to an associated respondent address in response to details of a transaction identified by the record's associated transaction ID and transaction server ID. The identifiers used in sent survey field 604 correspond to surveys stored in or accessible by user device 200. The surveys may be generated as described below or received from external sources.

Date sent field 605 indicates a date on which an associated survey was transmitted to an associated respondent address. The date may be used to determine whether to transmit another survey to the address. For example, survey application 292 may be operated so that a maximum of two surveys per month are transmitted to a single address. In such a case, date sent field 605 is examined to determine whether the two survey per month limit will be violated by transmission of a survey to a particular address.

It should be noted that sent survey database 296 of FIG. 6 represents transmission of surveys to a plurality of respondents based on transactions managed by a plurality of transaction servers such as help desk server 400. Moreover, some represented transmissions were sent to a single address based on transactions monitored by different transaction servers. In this regard, embodiments of the invention may be used in conjunction with servers and databases that manage transactions other than help desk transactions, including a contacts database or any other database for which a record includes information such as an electronic mail address that can be used transmit a survey to a respondent.

Response Database

FIG. 7 illustrates a tabular representation of a portion of response database 396 according to embodiments of the invention. The portion illustrates transaction ID field 701, transaction server ID field 702, survey ID field 703, responses field 704 and comments field 705. As described below, the information stored in these fields may be received exclusively from respondent device 500 upon submission of a completed survey to response server 300.

Transaction ID field 701 and transaction server ID field 702 identify a record stored in a server that includes details of a particular transaction. As described above, usage of both these fields assists in the accurate identification of the record. The identified record is a record based on which a survey specified in survey ID field 703 was transmitted to a respondent. The responses and comments of associated responses field 703 and comments field 704 are therefore responses and comments to the specified survey.

Response server 300 may also store a survey question database (not shown) that describes the questions of each survey identified in survey ID field 703. Accordingly, each response in responses field 704 may be correlated to a question that the response answers. The survey question database may also be used to update surveys in a manner to be described below.

Transaction database

A tabular representation of a portion of transaction database 494 is illustrated in FIG. 8. Transaction database 494 includes, for each illustrated record, ticket ID field 801, date and time opened field 802, problem field 803, resolution field 804, date and time closed field 805, and client field 806. The data stored in these fields may be generated during normal execution of help desk application 492 that is unrelated to embodiments of the present invention.

Ticket ID field 801 corresponds to transaction ID fields of the above-described databases. Accordingly, ticket ID field 801 of a record identifies a transaction described by the remaining fields of the record. In this regard, date and time opened field 802 specifies when the help desk transaction began (i.e., a help desk “ticket” was opened), problem field 803 describes a problem to be solved by the transaction, resolution field 804 specifies how the problem was resolved, date and time closed field 805 specifies when the help desk transaction ended (i.e., the help desk “ticket” was closed), and client field 806 identifies a person for whom the transaction was performed. As shown, client field 806 specifies an electronic mail address and therefore may be accessed by user device 200 to determine to whom a survey should be transmitted based on an associated transaction.

It is contemplated that each of databases 296, 396 and 494 may include many more records than those shown and that each record may include associated fields other than those illustrated. It should also be noted that the tabular illustrations and accompanying descriptions merely represent relationships between stored information. A number of other arrangements may be employed besides the ones suggested.

Process Flow

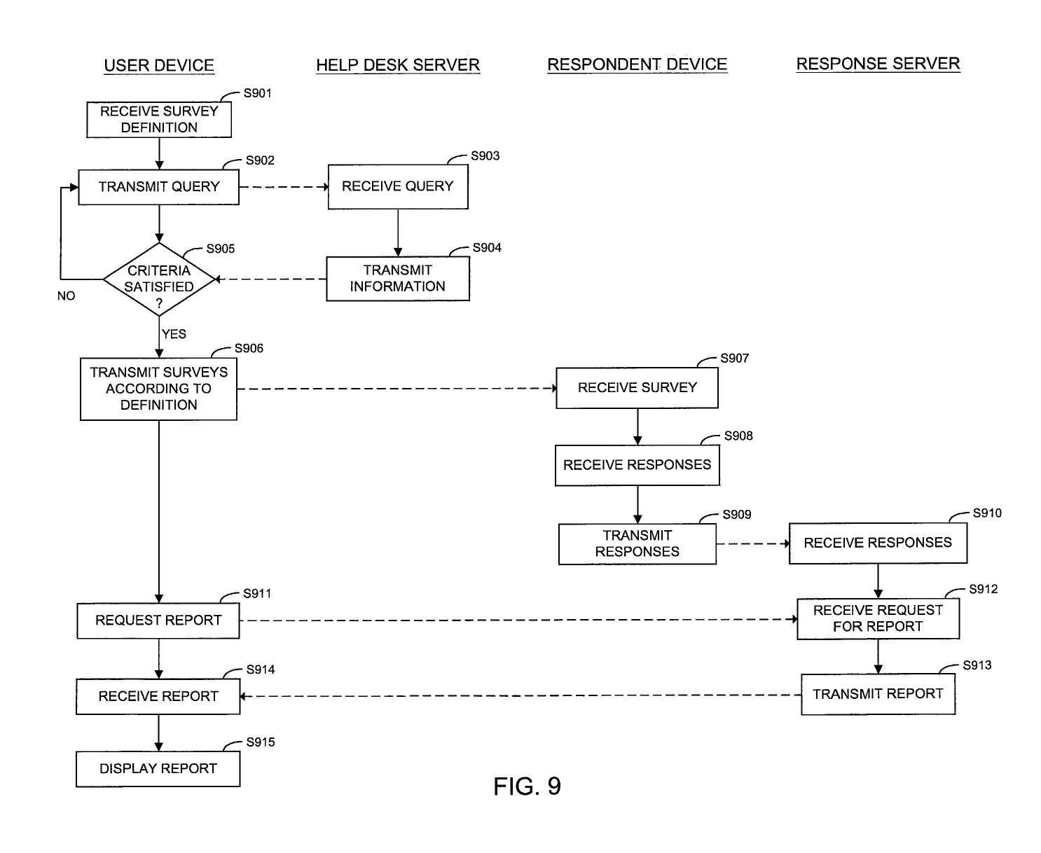

FIG. 9 comprises a flow diagram of process steps for administering a survey according to some embodiments of the present invention. Although various ones of process steps are shown and described as embodied in respective ones of user device 200, response server 300, help desk server 400 and respondent device 500, it should be noted that some of these process steps may be performed by either of at least two of these devices or by another device.

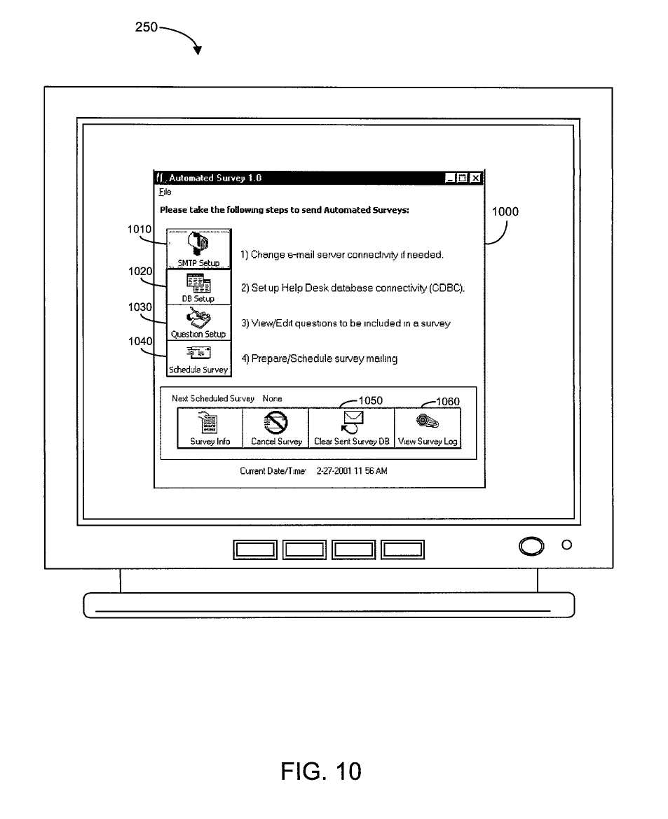

Initially, in step S901, user device 200 receives a definition of a survey input by a user. According to the present embodiment of step S901, the user operates user device 200 to execute survey application 292 and, in response, interface 1000 is displayed by display 250 as shown in FIG. 10. Interface 1000 includes buttons 1010 through 1040, which may be used to define a survey in step S901.

Button 1010 provides an interface to designate an SMTP server through which electronic mail messages including surveys will be transmitted, and button 1020 provides an interface for designating a database and fields of the database that include information usable to determine whether criteria are satisfied. As described above, a survey may be transmitted based on a determination that criteria, such as completion of a transaction, are satisfied. Button 1030 provides an interface that allows a user to review, add, edit and delete survey questions, while button 1040 provides an interface for controlling the frequency, timing and volume of survey transmission. Also included in interface 1000 are button 1050 and button 1060, the functions of which will be described below.

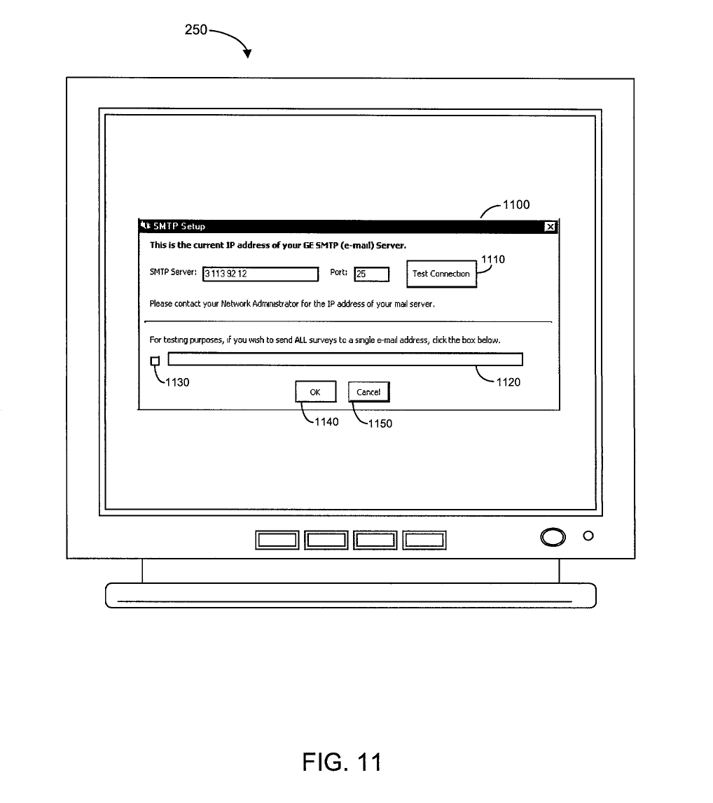

FIG. 11 shows interface 1100 as displayed by display 250 in response to user selection of button 1010 in step S901. Interface 1100 includes areas to specify an IP address or a URL of an SMTP server through which an electronic mail message including a survey should be transmitted, as well as button 1110 which may be selected to test a connection between user device 200 and the SMTP server. Interface 1100 also includes test address area 1120 and associated check box area 1130. If check box 1130 is selected by the user, all surveys to be transmitted will be transmitted to an electronic mail address specified in test address area 1120 rather than to an address of a respondent according to normal operation of survey application 292.

Upon selection of OK button 1140, the information input into interface 1100 is accepted so that application 292 will operate accordingly, interface 1100 is dismissed, and interface 1000 is displayed. Cancel button 1150 may be selected simply to dismiss interface 1100 and display interface 1000, thereby ignoring any changes entered into interface 1100.

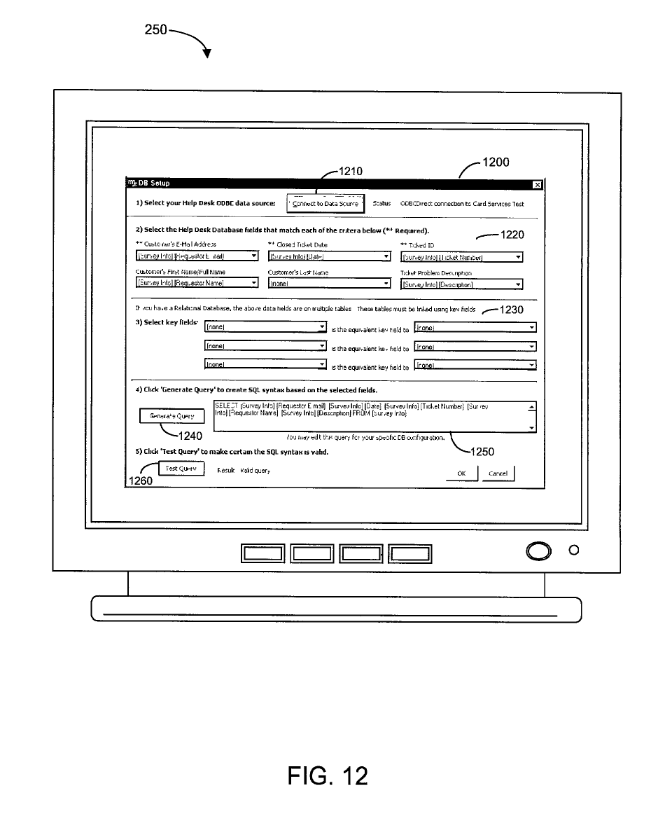

Continuing with the definition of a survey under step S901, selection of button 1020 of interface 1000 causes display of interface 1200 as shown in FIG. 12. Button 1210 of interface 1200 may be selected to launch a known Visual Basic tool provided by survey application 292 to access an ODBC-compliant data source such as transaction database 494. The ODBC driver function provided by certain operating systems may also be used to establish such access. Once access is gained, the pull-down menus of area 1220 will be populated with field names of the accessed database. Listed above each pull-down menu are descriptions of information used by the present embodiment to determine whether particular criteria are satisfied, and therefore to determine whether an associated survey should be sent. The information may also or alternatively be used to generate an electronic mail message including the survey. In operation, a user selects from each pull-down menu a field that includes information matching the description listed above the pull-down menu.

In a case that the fields to be queried are located in two or more linked tables, area 1230 allows the user to specify key fields that link the tables. As shown, this embodiment allows the user to query up to three linked tables. Selection of button 1240 causes a database query to be generated based on the inputs to interface 1200 and causes display of the query in area 1250. The user may edit the query, and may use button 1260 to check the syntax of the query. Moreover, the OK and Cancel buttons of interface 1200 operate similarly to the respective buttons of interface 1100. It should be noted that the features of interface 1200 advantageously provide efficient connection and linkage to fields of a database.

The present invention is not to be deemed limited to the listed descriptions shown in FIG. 12. Any information may be used to determine whether criteria are satisfied and therefore whether surveys should be sent based thereon, including information unrelated to help desk transactions. Moreover, application 292 may administer several surveys, with each survey being associated with different fields and criteria specified in interface 1200.

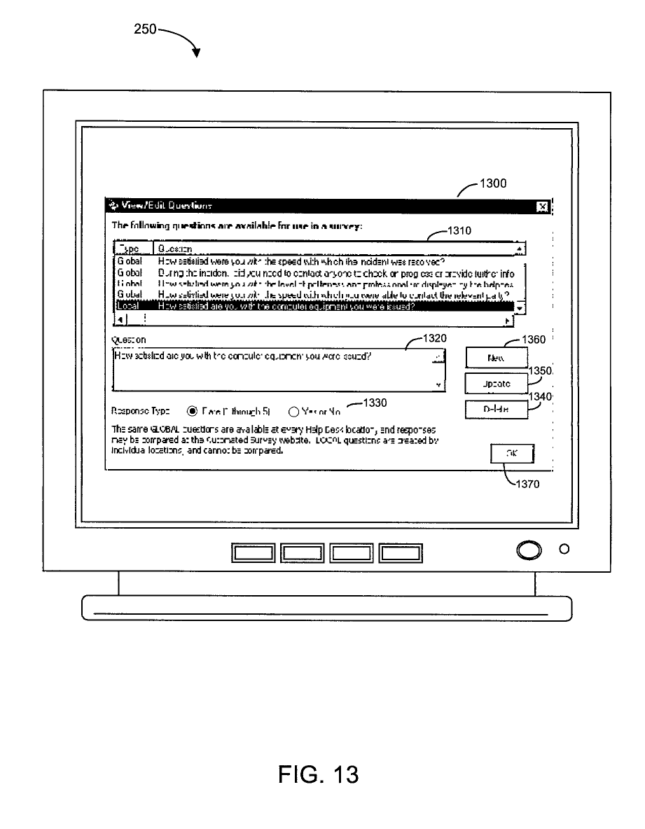

Interface 1300 of FIG. 13 is displayed by display 250 in response to user selection of button 1030 of interface 1000. Area 1310 shows current questions provided by application 292, and also identifies whether a question is a Global question or a Local question. Global questions are included in all surveys transmitted by survey application 292, and Local questions may be added, edited or deleted. Because global queries are included in all surveys, responses to these questions may be used to compare services provided by various transaction servers. Once the user selects a question in area 1310, the question is displayed in area 1320. Also displayed in area 1330 is an indication of whether the selected question may be answered by Yes/No or by a rating between 1 and 5. The displayed question may be deleted by selecting button 1340 or may be updated by editing the question in area 1320 and/or by changing the designation in area 1330, and by thereafter selecting button 1350. A new question may be added by selecting button 1360 and by completing areas 1320 and 1330. Selection of OK button 1370 implements changes input in interface 1300 and returns the user to interface 1000.

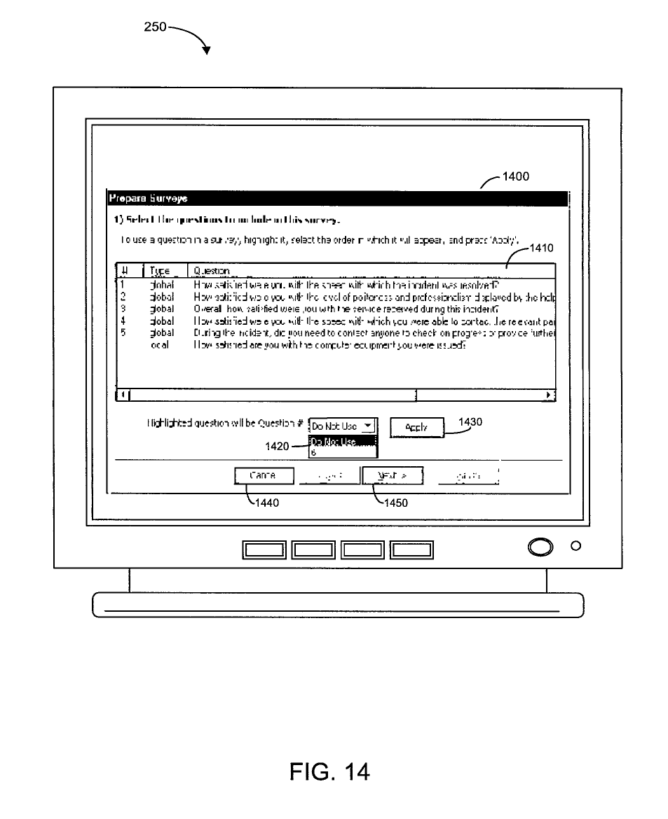

In a case that the user selects button 1040, interface 1400 is displayed by display 250 as shown in FIG. 14. The user may select questions to be included in a survey by highlighting a question in area 1410, by selecting a question number from pull-down menu 1420, and by selecting button 1430. A highlighted question may be similarly removed from a survey by selecting “Do Not Use” from menu 1420 and by selecting button 1430. The questions shown in area 1410 are those defined using interface 1300. Cancel button 1440 dismisses interface 1400 while ignoring changes made therein and returns the user to interface 1000.

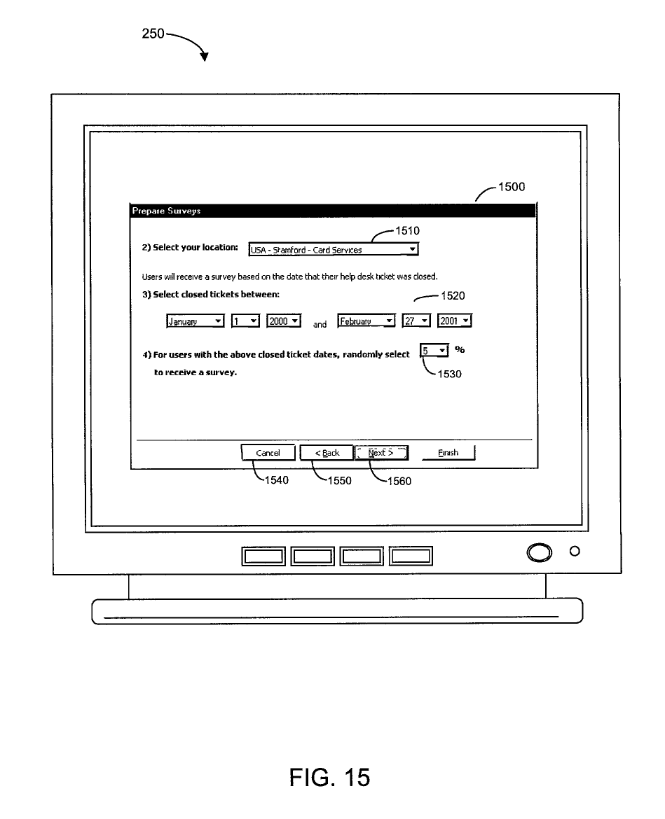

Selection of Next button 1450 results in display of interface 1500 of FIG. 15. Pull-down menu 1510 allows the user to specify a location and therefore a particular help desk server. As mentioned above, some embodiments of the invention allow any transaction server to be specified in menu 1510. Preferably, the database selected using button 1210 of interface 1200 corresponds to the selected location.

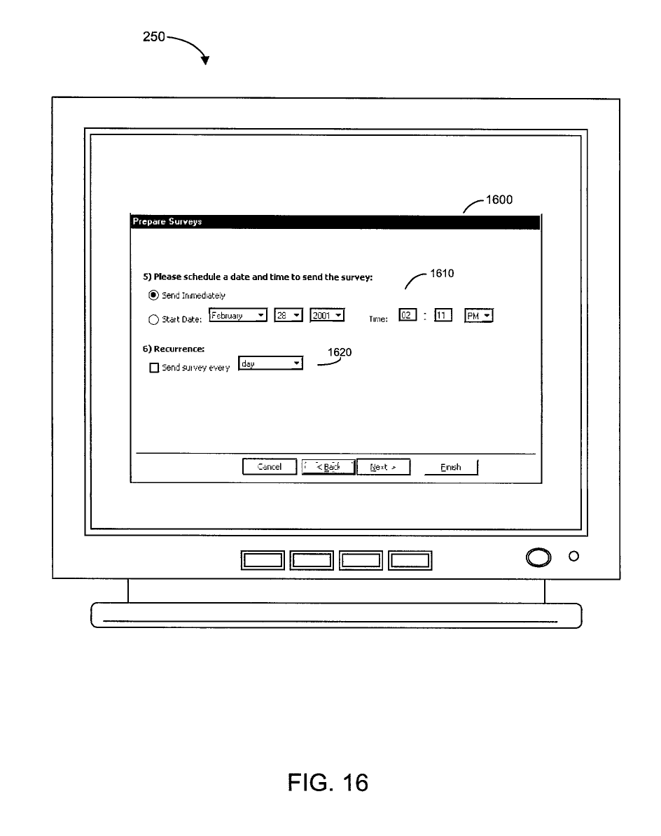

Area 1520 is used to specify a date range of transactions of interest. That is, surveys will be sent only based on transactions that satisfy the specified criteria (a closed ticket according to the present example) and which satisfy the criteria within the specified date range. Additionally, pull-down menu 1530 allows the user to specify a percentage of those transactions for which surveys should be transmitted. Application 292 may also provide that no single respondent receives more than one survey per batch of transmitted surveys. No current system is believed to include at least these latter two advantageous options. Cancel button 1540 dismisses interface 1500 while ignoring changes made in both interface 1400 and 1500 therein and returns the user to interface 1000. Back button 1550 returns the user to interface 1400 while ignoring the changes made in interface 1500, and Next button 1560 causes display of interface 1600 of FIG. 16.

The user may specify a schedule by which to send surveys in area 1610 of interface 1600. Of course, the surveys will be sent based on satisfied criteria specified by application 292 (e.g., a closed help desk ticket) and on the date range specified in interface 1500. Area 1620 allows a user to specify a recurrence period for transmitting subsequent surveys. In some embodiments, the date range specified in interface 1500 is incremented according to the recurrence period when determining subsequent surveys to transmit. Such an arrangement may ensure that identical surveys are not recurringly transmitted based on a single transaction. Cancel, Next and Back buttons of interface 1600 operate as described above.

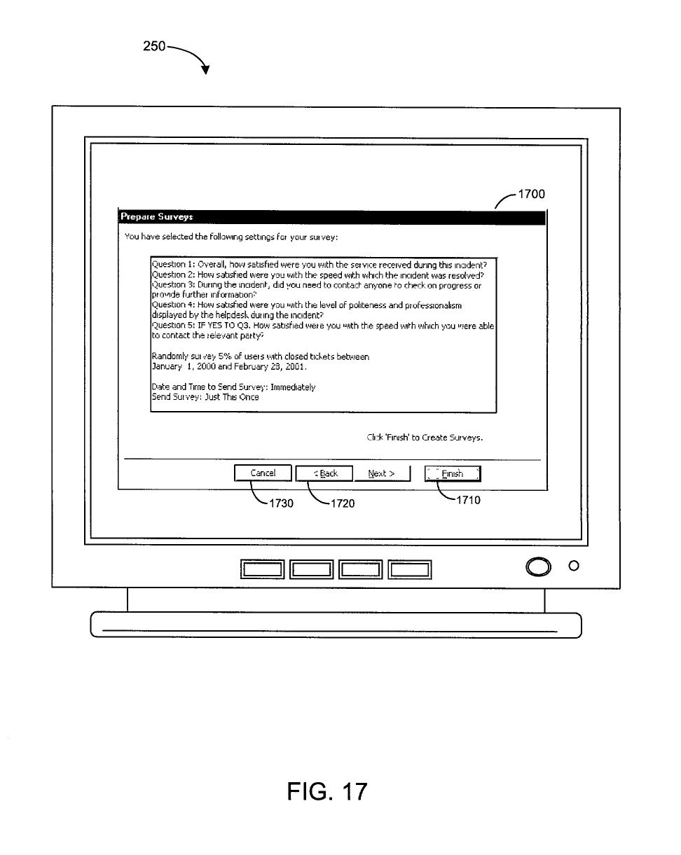

FIG. 17 illustrates display 250 after selection of Next button of interface 1600. Displayed interface 1700 provides the user with a single location for reviewing portions of a survey definition input using interfaces 1000 through 1600. If the portions are satisfactory to the user, the user selects Finish button 1710 and the definition is received and implemented by user device 200. If not, the user may select Back button 1720 to change information input to interfaces 1400 through 1600, or Cancel button 1730 to cause the information to be ignored and re-display of interface 1000.

Returning to the process steps of FIG. 9, user device 200 transmits a query to help desk server 400 in step S902. In this regard, the dotted lines of FIG. 9 are intended to represent data flowing between the devices listed therein. The transmitted query complies with ODBC protocol and requests information from the database fields defined in interface 1200 during step S901.

The query is transmitted in step S902 in order to determine whether any transactions described in transaction database 494 satisfy criteria specified by survey application 292 and to retrieve information related to these transactions, such as an email address of an associated respondent. In the present example, the criteria include completion of a transaction and a completion date falling within the date range specified in interface 1500. In order to determine if a transaction has been completed, the query requests information from date and time closed field 805 of transaction database 494. The query is received in step S903 by an ODBC-compliant DBMS executing in help desk server 400 and information responsive to the query is transmitted to user device 200 in step S904.

The transmitted information is evaluated by user device 200 in step S905 to determine transactions for which the criteria are satisfied. If no transactions satisfy the criteria, flow returns to step S902. If such transactions are identified, surveys are transmitted in step S906 according to the definition received in step S901. First, a survey is generated based upon the received definition and an electronic mail message is created including the survey for each identified transaction.

The electronic mail message may be created by formatting the survey as an HTML page and by creating an electronic mail message including the page. Moreover, the page includes non-displayed executable code and data specifying a survey ID, the survey questions, a type of each question, a transaction server ID identifying the transaction server that stored the information based on which the message was created, a transaction ID, and an IP address of response server 300. This data is used by respondent device 500 to transmit responses to response server 300 and by response server 300 to generate reports of survey results in a manner that will be described in detail below. For each identified transaction, the thusly-created message is addressed to an electronic mail address that is associated with the transaction in field 806 of database 494. The message is then transmitted to each address according to the schedule specified in area 1610 of interface 1600.

In this regard, it may be determined that the message has already been sent to a particular address based on an identified transaction associated with the address. This determination may be based on information stored in sent survey database 296. Specifically, a ticket ID and an identifier of the help desk server associated with the transaction may match a transaction ID and transaction server ID of a record in sent survey database 296. In such a case, the message is not transmitted to the address associated with the transaction. The user may control this feature by using button 1060 of interface 1000 to view the contents of database 296, and by using button 1050 to clear all fields of database 296.

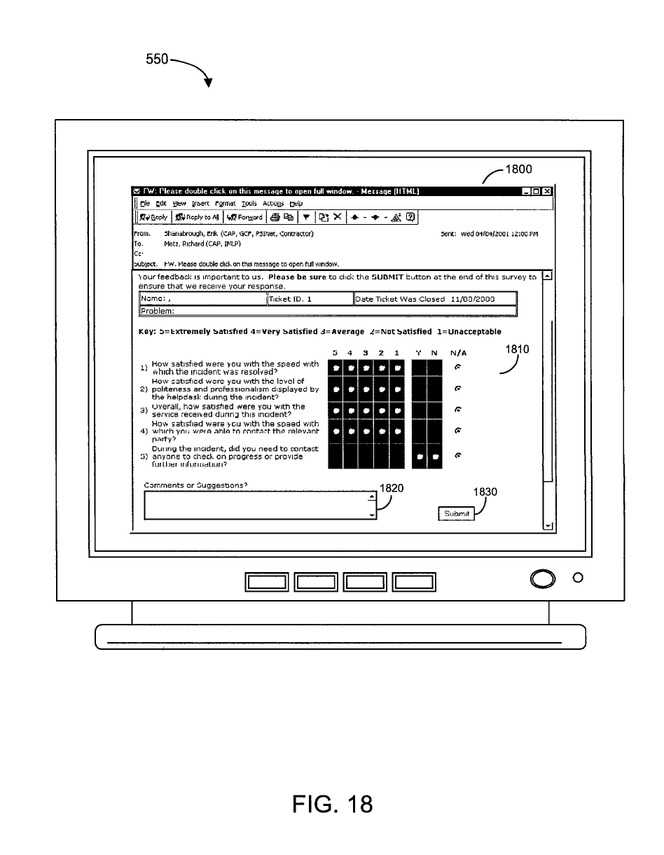

The electronic mail message including the survey is received by respondent device 500 in step S907. More particularly, respondent device 500 executes electronic mail client 592 to retrieve electronic mail messages addressed to the client from a mail server. FIG. 18 illustrates message 1800 as displayed by display 550. As shown, message 1800 appears to be a standard electronic mail message including an HTML page, thereby providing the respondent with familiarity and a comfort level during her interaction with message 1800. This interaction may consist of the respondent using input device 540 to select responses to the questions posed in response area 1810. The respondent may also insert comments and suggestions in area 1820. Upon completing the survey, the respondent terminates the interaction by selecting submit button 1830.

As mentioned above, the selection of submit button 1830 causes execution of code to receive the responses selected by the respondent in step S908. The received responses are formatted according to a protocol for transmitting data to a Web server, such as CGI or ASP, and the formatted responses are transmitted in step S909 to an IP address that is specified in the HTML page and that corresponds to response server 300.

Response server 300 receives the responses and any input comments in step S910. Also received in step S910 are non-displayed data included in the survey's HTML page. This data includes a survey ID, survey questions, a survey type, a transaction ID, and a transaction server ID. The responses and comments are stored in association with the transaction ID and transaction server ID as shown in response database 396 of FIG. 7. The received survey ID, survey questions, and survey type are used by response server 300 to create and maintain a record describing the survey (not shown herein). Such a feature allows response server 300 to generate survey reports even though server 300 has no knowledge of a survey prior to reception of responses to the survey from respondent device 500.

In some cases, a newly-received survey ID corresponds to a previously-received survey ID but survey questions received with the newly-received survey ID do not correspond to questions stored in association with the previously-received survey ID. Response server 300 therefore determines that the survey has changed and operates accordingly. For example, three records of response database 396 are associated with survey ID “Survey1”. However, each record indicates a different number of responses in associated responses field 704. The differences reflect changes to the survey associated with survey ID “Surveyl” that were determined based on non-displayed HTML data received with associated responses.

Next, in step S911, user device 200 requests a report including survey results from response server 300. User device 200 may request the report by executing a Web browser to request an appropriate Web page provided by Web server 394 of response server 300. The request is received in step S912. During step S912, Web server 394 may require some type of security authorization to prevent unauthorized access to the report.

Response server 300 generates the report in step S912 based on the data stored in response database 396 and on the stored survey questions. Of course, the report may be generated after step S910 and before the request is received in step S912. The report is created as a Web page and is transmitted to user device 200 by Web server 394 in step S913. User device 200 receives the Web page in step S914 and displays the Web page in step S915.

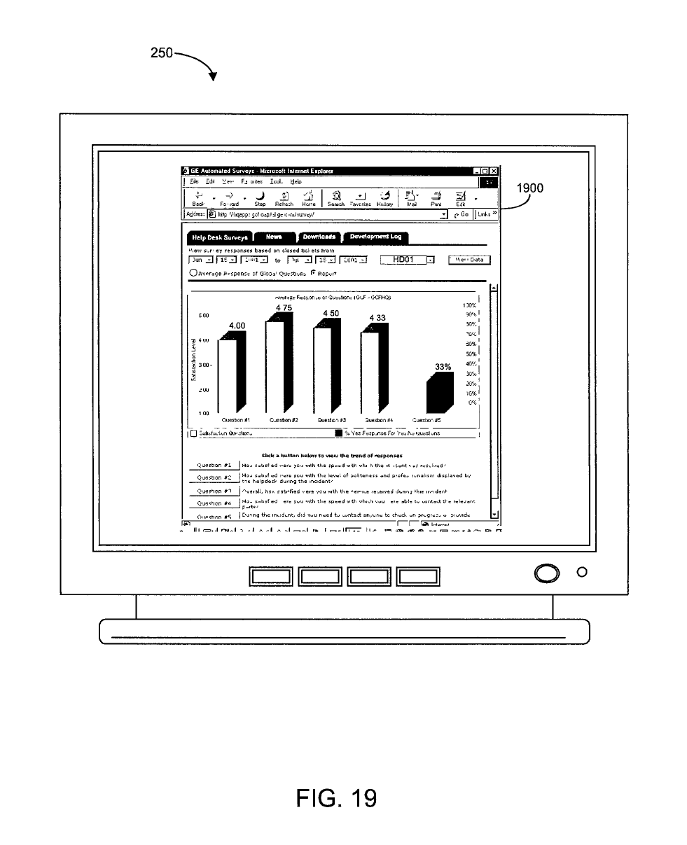

FIG. 19 shows Web page 1900 as displayed by display 250. Web page 1900 includes a report of survey results according to some embodiments of the invention. The graphed data is computed based on the responses stored in response database 396, while the illustrated questions are taken from survey information maintained by response server 300.

It should be noted that process steps 900 reflect one specific embodiment of the present invention, and that other embodiments may vary widely in operation. In some embodiments, the steps performed and data stored by response server 300 may be performed and stored by user device 200. Also in some embodiments, survey application 292 includes process steps executable to provide an interface for specifying criteria based on which a survey may be transmitted and for associating fields of a database with the specified criteria. Also, embodiments of the invention may allow a user to associate one survey with a set of criteria that may be evaluated using fields stored in a particular database server, and to associate another survey with a different set of criteria that may be evaluated using fields stored in the same or another database server. Along these lines, embodiments also provide for criteria that are evaluated based on fields stored in more than one database server.

Although the present invention has been described with respect to particular embodiments and alternative arrangements thereof, those skilled in the art will note that various substitutions may be made to those embodiments and arrangements without departing from the spirit and scope of the present invention.

What is claimed is:

1. A method for eliciting a response from a respondent, comprising:
receiving an indication that a transaction has been completed; and
transmitting, in response to the indication, an electronic mail message to a respondent, the message including one or more questions concerning the transaction.

2. A method according to claim 1, wherein the transaction comprises a help desk transaction.

3. A method according to claim 2, wherein the indication comprises an indication that a help desk ticket submitted by the respondent has been closed.

4. A method according to claim 1, further comprising:
determining whether or not to transmit the one or more questions based on a specified percentage of completed transactions for which questions are to be transmitted.

5. A method according to claim 4, further comprising:
determining whether or not the one or more questions have been previously transmitted to the respondent,
wherein the transmitting step is performed only if the one or more questions have not been previously transmitted to the respondent.

6. A method according to claim 1, further comprising:
determining whether or not the one or more questions have been previously transmitted to the respondent,
wherein the transmitting step is performed only if the one or more questions have not been previously transmitted to the respondent.

7. A method according to claim 1, further comprising:
determining whether or not any questions have been previously transmitted to the respondent,
wherein the transmitting step is performed only if no questions have been previously transmitted to the respondent.

8. A method according to claim 1, further comprising:
querying a local database to identify completed transactions.

9. A method according to claim 1, wherein the one or more questions are transmitted according to a predefined transmission schedule.

10. A method according to claim 1, wherein the transmitting step comprises:
receiving a command from a user to transmit the one or more questions.

11. A computer-readable medium storing processor-executable process steps to elicit a response from a respondent, the steps comprising:
a step to receive an indication that a transaction has been completed; and
a step to transmit, in response to the indication, an electronic mail message to a respondent, the message including one or more questions concerning the transaction.

12. A system for administering surveys, comprising:
a first device for receiving an indication that a transaction has been completed and for transmitting, in response to the indication, one or more questions concerning the transaction to a respondent in an electronic mail message; and
a second device for receiving one or more responses to the one or more questions, for generating a report based on the one or more responses, and for providing the report to the first device.

13. A method for transmitting a survey, comprising:
generating a survey comprising one or more questions;
defining a transaction in response to the completion of which the survey should be transmitted;
detecting completion of the transaction; and
transmitting an electronic mail message including the survey to a respondent in response to the detection.

14. A method according to claim 13, further comprising:
receiving one or more responses to the one or more questions.

15. A method according to claim 13, further comprising:
specifying a connection to an electronic mail server.

16. A method according to claim 13, wherein the step of detecting the event comprises:
defining fields of a database corresponding to the transaction; and
querying the database for information populating the defined fields.

17. A computer-readable medium storing processor-executable process steps to elicit a response from a respondent, the steps comprising:
a step to generate a survey comprising one or more questions;
a step to define a transaction in response to the completion of which the survey should be transmitted;
a step to detect completion of the transaction; and
a step to transmit the survey to a respondent in an electronic mail message in response to the detection.

18. A method for producing survey results, comprising:
receiving one or more responses to one or more questions transmitted to a respondent in an electronic mail message in response to detection of a completed transaction;
generating a report based on the one or more responses; and
transmitting the report.

19. A method according to claim 18, wherein the one or more questions were transmitted by a first device and wherein the report is transmitted to the first device.

20. A computer-readable medium storing processor-executable process steps to elicit a response from a respondent, the steps comprising:
a step to receive one or more responses to one or more questions transmitted to a respondent in an electronic mail message in response to detection of a completed transaction;
a step to generate a report based on the one or more responses; and
a step to transmit the report.

21. A system for administering surveys, comprising:
a client device for generating a survey comprising one or more questions, for defining a transaction, for receiving an indication that the transaction has been completed, and for transmitting, in response to the indication, an electronic mail message comprising one or more questions concerning the transaction to a respondent;
a transaction device for storing data indicating that the transaction has been completed and for transmitting the indication that the transaction has been completed; and
a server device for receiving one or more responses to the one or more questions, for generating a report based on the one or more responses, and for providing the report to the client device.

22. A system according to claim 21, wherein the client device queries a database of the transaction device according to a schedule to determine whether the transaction has been completed.

23. A system according to claim 21, wherein the server device receives the responses and the one or more questions from a respondent device.

24. A method for administering a survey, comprising:
receiving indications from a user of one or more fields of a database, the fields specifying information;
determining that the one or more criteria have been satisfied based on information specified in the one or more fields; and
transmitting a survey to a respondent based on the determination.

25. A method according to claim 24, further comprising:
receiving an indication of the database from the user; and
querying the database to receive indications of fields comprising the database.

26. A method according to claim 24, further comprising:
generating the survey based on one or more questions received from the user.

27. A method according to claim 24, wherein the determining step comprises:
receiving information specified in one or more of the one or more fields indicating that the one or more criteria have been satisfied.

28. A method according to claim 24, wherein the one or more criteria comprise the completion of a transaction.

29. A method according to claim 24, wherein the survey is transmitted via electronic mail.

30. A method according to claim 29, wherein the survey comprises an electronic mail message.

31. A computer-readable medium storing processor-executable process steps to administer a survey, the process steps comprising:
a step to receive indications from a user of one or more fields of a database, the fields specifying information;
a step to determine that the one or more criteria have been satisfied based on information specified in the one or more fields; and
a step to transmit a survey to a respondent based on the determination.

32. A medium according to claim 31, the process steps further comprising:
a step to receive an indication of the database from the user; and
a step to query the database to receive indications of fields comprising the database.

33. A medium according to claim 31, the process steps further comprising:
a step to generate the survey based on one or more questions received from the user.

34. A medium according to claim 31, wherein the step to determine comprises:
a step to receive information specified in one or more of the one or more fields indicating that the criteria have been satisfied.

35. A medium according to claim 31, wherein the survey is transmitted via electronic mail.

36. A medium according to claim 35, wherein the survey comprises an electronic mail message.

37. An apparatus for administering a survey, comprising:
a processor;
a display; and
a storage device in communication with the processor and storing instructions adapted to be executed by the processor to:
receive indications from a user of one or more fields of a database, the fields specifying information;
determine that the one or more criteria have been satisfied based on information specified in the one or more fields; and
transmit a survey to a respondent based on the determination.

38. An apparatus according to claim 37, the instructions further adapted to be executed by the processor to:
receive an indication of the database from the user; and
query the database to receive indications of fields comprising the database.

39. An apparatus according to claim 37, the instructions further adapted to be executed by the processor to:
generate the survey based on one or more questions received from the user.

40. An apparatus according to claim 37, wherein the instructions adapted to be executed by the processor to determine that a transaction has been completed are further adapted to be executed by the processor to:
receive information specified in one or more of the one or more fields indicating that the one or more criteria have been satisfied.

41. An apparatus according to claim 37, wherein the survey is transmitted via electronic mail.

42. An apparatus according to claim 41, wherein the survey comprises an electronic mail message.
